(19) United States
(12) Patent Application Publication
(10) Pub. No.: US 2026/0351896 A1
(43) Pub. Date: Nov. 5, 2026

(54) CABLE-END CONNECTOR ASSEMBLY, BOARD-END CONNECTOR ASSEMBLY, AND HIGH-CURRENT CONNECTOR ASSEMBLY

(71) Applicant: BIZLINK INTERNATIONAL CORP., New Taipei City (TW)

(72) Inventors: Zhongming LIN, New Taipei City (TW); Zihao CHEN, New Taipei City (TW)

(21) Appl. No.: 19/660,182

(22) Filed: Apr. 27, 2026

(30) Foreign Application Priority Data
Apr. 30, 2025 (CN) 202510564201.2
Apr. 30, 2025 (CN) 202520854821.5

(51) Int. Cl. H01R 13/621; H01R 12/75

(52) U.S. Cl. CPC H01R 13/621; H01R 12/75

(57) ABSTRACT

A cable-end connector assembly includes an insulating base, at least one positioning module, a plurality of conductive terminal modules, and a plurality of cables. The insulating base includes a front panel, a plurality of protruding tubular portions extending forward from the front panel, and two positioning portions disposed on opposite sides of the insulating base. Each of the protruding tubular portions defines a passage extending through the insulating base. The at least one positioning module is disposed on the two positioning portions and raised from the front panel. The at least one positioning module includes a fastening structure configured to secure the cable-end connector assembly. The conductive terminal modules are respectively disposed within the protruding tubular portions. The cables are individually and electrically connected to the conductive terminal modules.

### CROSS REFERENCE TO RELATED APPLICATIONS

This application claims priority to China Application Serial Number 202520854821.5, filed Apr. 30, 2025, and China Application Serial Number 202510564201.2, filed Apr. 30, 2025, the disclosures of which are incorporated herein by reference in their entireties.

### BACKGROUND

### Field of Invention

The present disclosure relates to a cable-end connector assembly, a board-end connector assembly, and a high-current connector assembly.

### Description of Related Art

A connector is a device for connecting an electronic product to a power source or another electronic product. The connector usually includes conductive terminals, cables, and a main body formed by molding at a connection between the conductive terminals and the cables.

A cable-end connector and a board-end connector are usually used in combination and achieve connection by being inserted into each other. A server is usually provided with a plurality of board-end connectors for the cable-end connectors to be inserted thereinto, and the two connectors achieve connection by being inserted into each other. In some existing servers, a corresponding height of each of the board-end connectors is generally only 4 centimeters, and a width thereof is also fixed. In addition, the server is provided with a plurality of slot-type board-end connectors arranged thereon, with some of the board-end connectors being arranged in an array. Since many connectors need to be inserted, requirements for a thickness and dimensions of the sockets (the board-end connectors) formed on the server are also relatively strict.

In addition, for some high-current connectors, the connectors need to cooperate with a plurality of arranged terminals. When the terminals are mostly arranged laterally, a length of the cable-end connector or the board-end connector is increased. Moreover, in order to position the cable-end connector and the board-end connector after docking such that the relative positions thereof can be maintained after insertion, positioning modules (elastic pieces or elastic hooks) need to be disposed at two ends of the cable-end connector so as to cooperate with the board-end connector (hooks or engaging parts) to realize positioning connection. Therefore, when the terminals together with the positioning modules form a strip-shaped cable-end connector, a lateral length dimension is large. Under a condition that a dimensional space for disposing the connectors on the server is limited, in which a height and a width of a connector connection surface of the server are limited, effective spatial arrangement and utilization cannot be realized, and more connectors cannot be disposed and connected in series on a server cabinet.

Therefore, how to propose a cable-end connector assembly, a board-end connector assembly, and a high-current connector assembly that can solve the aforementioned problems is one of the problems that the industry is currently eager to invest in research and development resources to solve.

### SUMMARY

In view of this, one purpose of the present disclosure is to provide a cable-end connector assembly, a board-end connector assembly, and a high-current connector assembly that can solve the aforementioned problems.

In order to achieve the above objective, according to an embodiment of the present disclosure, a cable-end connector assembly includes an insulating base, at least one positioning module, a plurality of conductive terminal modules, and a plurality of cables. The insulating base includes a front panel, a plurality of protruding tubular portions extending forward from the front panel, and two positioning portions disposed on opposite sides of the insulating base. Each of the protruding tubular portions defines a passage extending through the insulating base. The at least one positioning module is disposed on the two positioning portions and raised from the front panel. The at least one positioning module includes a fastening structure configured to secure the cable-end connector assembly. The conductive terminal modules are respectively disposed within the protruding tubular portions. The cables are individually and electrically connected to the conductive terminal modules.

In order to achieve the above objective, according to an embodiment of the present disclosure, a board-end connector assembly is configured to be coupled with a cable-end connector assembly. The board-end connector assembly includes a main body, a board-end base, and a plurality of board-end terminals. The board-end base protrudes from the main body and has a plurality of sockets corresponding to a plurality of protruding tubular portions of the cable-end connector assembly. The board-end connector assembly has a plurality of recessed portions recessed from an outer sidewall of the board-end base. The board-end terminals are disposed in the sockets.

In order to achieve the above objective, according to an embodiment of the present disclosure, a high-current connector assembly includes a cable-end connector assembly and a board-end connector assembly. The board-end connector assembly is connected to the cable-end connector assembly. The cable-end connector assembly includes an insulating base, a plurality of conductive terminal modules, and a plurality of cables. The insulating base has a plurality of protruding tubular portions and at least one positioning module separated from the protruding tubular portions. The conductive terminal modules are disposed in the protruding tubular portions. The cables are electrically connected to the conductive terminal modules. The board-end connector assembly includes a board-end base, a plurality of sockets, and at least one positioning part. The board-end base is configured to be coupled with the cable-end connector assembly. The sockets are configured to receive the protruding tubular portions. The at least one positioning part is configured to be engaged with the at least one positioning module of the cable-end connector assembly.

### BRIEF DESCRIPTION OF THE DRAWINGS

The invention can be more fully understood by reading the following detailed description of the embodiment, with reference made to the accompanying drawings as follows:

FIG. 1 is a perspective view of a high-current connector assembly in accordance with an embodiment of the present disclosure;

FIG. 2 is a perspective view of a high-current connector assembly in accordance with an embodiment of the present disclosure;

FIG. 3 is a cross-sectional view of the high-current connector assembly based on a section A-A’ of FIG. 2 in accordance with an embodiment of the present disclosure;

FIG. 4 is an exploded view of the high-current connector assembly in accordance with an embodiment of the present disclosure;

FIG. 5 is another exploded view of the high-current connector assembly in accordance with an embodiment of the present disclosure; and

FIG. 6 is an exploded view of a cable-end connector assembly in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit the present disclosure. In other words, in some embodiments of the present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

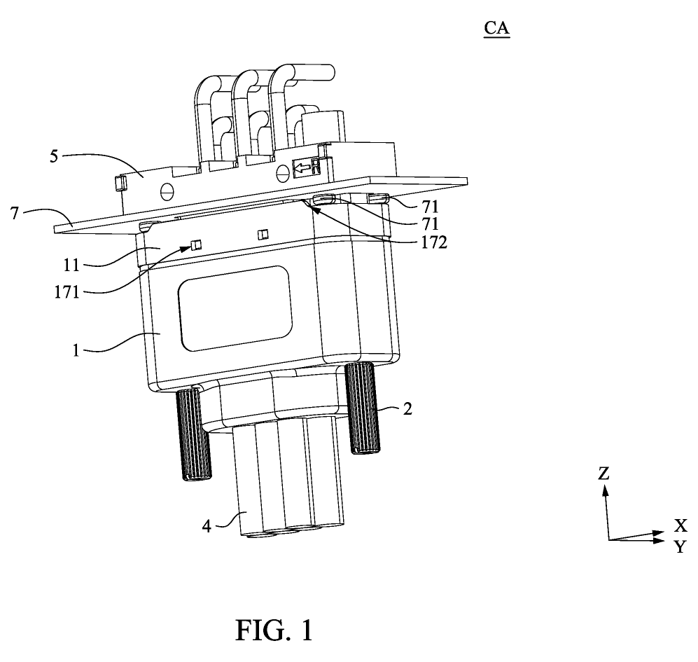

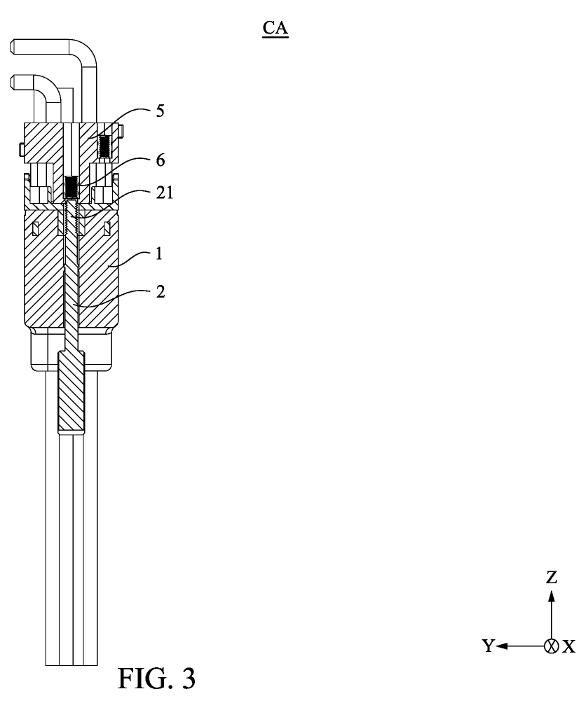

Reference is made to FIGS. 1-6 . The present disclosure provides a cable-end connector assembly 1. The cable-end connector assembly 1 includes an insulating base 11, at least one positioning module 2, a plurality of conductive terminal modules 3, and a plurality of cables 4. The insulating base 11 includes a front panel 12, a plurality of protruding tubular portions 13 extending forward from the front panel 12, and a plurality of positioning portions 14 disposed on opposite sides of the insulating base 11. Each of the protruding tubular portions 13 is hollowed and tubular. Each of the protruding tubular portions 13 defines a passage extending through the insulating base 11. The protruding tubular portions 13 are located between the two positioning portions 14. The at least one positioning module 2 is disposed on the positioning portions 14. The at least one positioning module 2 is separated from the protruding tubular portions 13 and is raised from the front panel 12. The positioning module 2 maintains a relative position between the front panel 12 and the board-end connector assembly 5 when the cable-end connector assembly 1 is connected to the board-end connector assembly 5. The conductive terminal modules 3 are respectively disposed within the protruding tubular portions 13. The cables 4 are electrically connected to the respective conductive terminal modules 3.

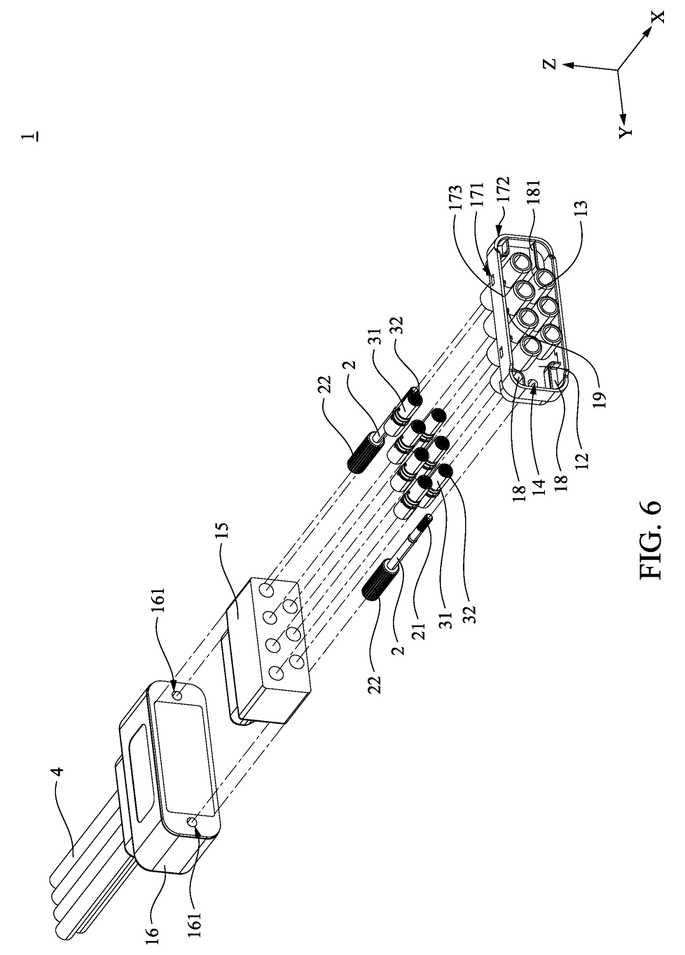

In this embodiment, as shown in FIG. 6, each of the conductive terminal modules 3 includes a conductive body 31 and an annular terminal member 32. The annular terminal member 32 is disposed within a cup-shaped groove at a front end of the conductive body 31. The conductive body 31 has a connection surface at a rear end thereof. The connection surface (not shown) is configured to be electrically connected to a corresponding cable 4.

Specifically, the positioning portions 14 have a plurality of through holes extending through the insulating base 11. The at least one positioning module 2 includes a metal stem respectively received in the corresponding through hole. A front end of the metal stem protrudes from the front panel 12. The protruding portions can be inserted into corresponding positioning structures disposed on the board-end connector assembly 5 for limiting when the cable-end connector assembly 1 is inserted into the board-end connector assembly 5, such that the front panel 12 and the board-end connector assembly 5 can maintain a relative position. The at least one positioning module 2 further includes a threaded portion 21 disposed at a front end thereof. The threaded portion 21 protrudes from the front panel 12. The board-end connector assembly 5 has at least one positioning part 6 configured to be engaged with the at least one positioning module 2. More specifically, the positioning part 6 of the board-end connector assembly 5 is threadedly connected to the threaded portion 21 located at the front end of the metal stem.

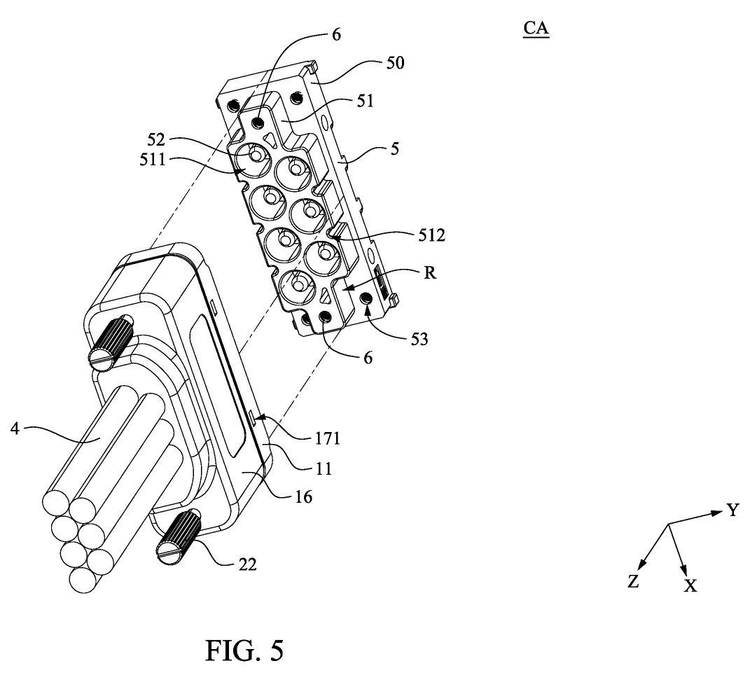

As shown in FIGS. 5 and 6 , the cable-end connector assembly 1 further includes an internal mold 15 and an external mold 16. The internal mold 15 wraps the insulating base 11 and at least one portion of the cables 4. The external mold 16 wraps the internal mold 15. The external mold 16 has connecting holes 161. The connecting holes 161 are located at opposite sides of the external mold 16 and run through the external mold 16. The connecting holes 161 correspond to a rear side of the positioning portions 14 and are located outside the internal mold 15. In this embodiment, the positioning module 2 is a screw. The screw sequentially passes through the connecting hole 161 of the external mold 16 and the through hole of the insulating base 11 and then protrudes from the front panel 12. In this embodiment, the positioning part 6 is a nut. When the cable-end connector assembly 1 is connected to the board-end connector assembly 5 and secured, a front end of the at least one positioning module 2 serving as the screw is inserted into the nut, and by manipulating a rear end of the screw, the front end of the screw is fastened into the nut. In some embodiments, the positioning module 2 includes a manipulating section 22 disposed at a rear end thereof and extending outward from the external mold 16, so as to facilitate a rotating operation of the positioning module 2.

In this embodiment, the protruding tubular portions 13 are divided into an upper row and a lower row, and the protruding tubular portions 13 are staggered with each other. A quantity of the protruding tubular portions 13 in the upper row is less than a quantity of the protruding tubular portions 13 in the lower row. Compared with a lateral arrangement manner, the arrangement manner of the upper row and the lower row with different quantities can shorten a length and utilize space in a height direction. Moreover, suitable spaces are provided on two sides of the front panel 12 to dispose the positioning portions 14, so as to reasonably utilize the spatial arrangement and further allow the structure more compact. In this embodiment, the insulating base 11 includes seven protruding tubular portions 13, in which three protruding tubular portions 13 are located in the upper row, and four protruding tubular portions 13 are located in the lower row. The board-end connector assembly 5 includes merely one ground terminal, and the ground terminal can be located at an outermost side of the lower row.

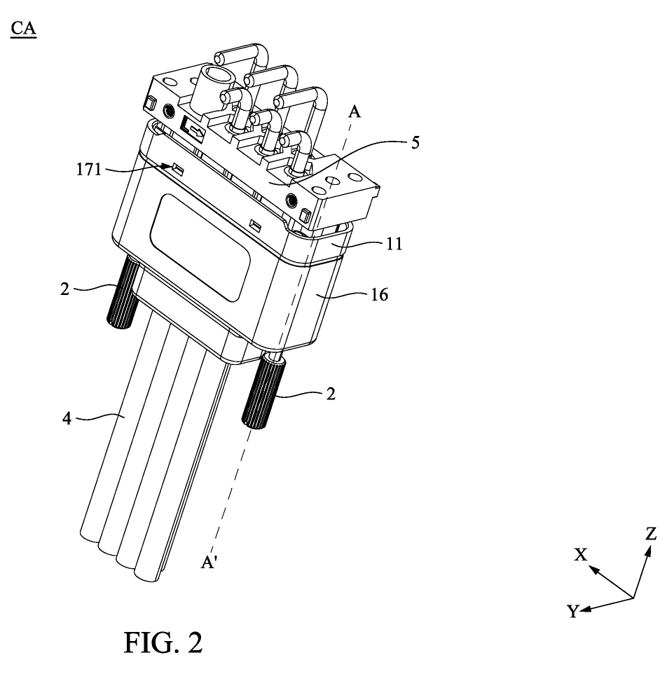

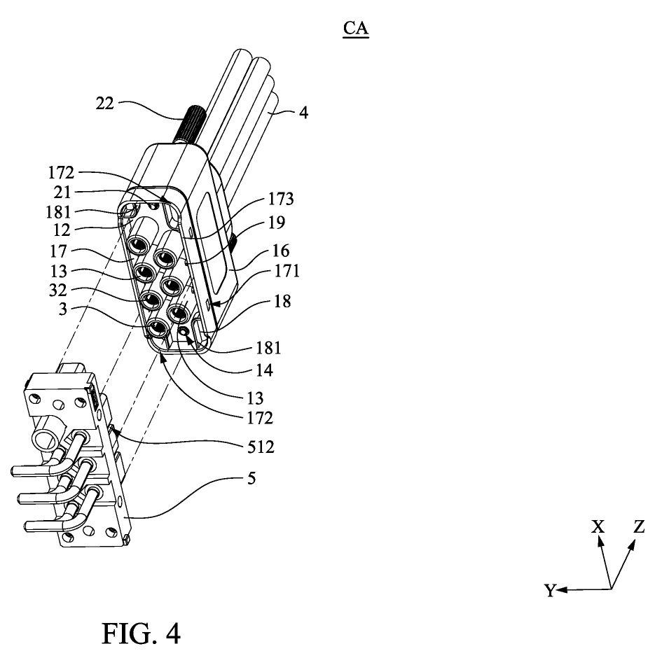

Further, the insulating base 11 further includes a wall 17 extending forward from the front panel 12. The wall 17 surrounds the front panel 12 such that the protruding tubular portions 13 are enclosed therein. As shown in FIGS. 2 and 4, the wall 17 has at least one observation hole 171 located at two opposite side surfaces of the wall 17. The observation hole 171 is located at a front side of the front panel 12. In some embodiments, two observation holes 171 are disposed on each of a plurality of side surfaces of the wall 17. Since the observation hole 171 is located exactly at the front side of the front panel 12, whether the cable-end connector assembly 1 and the board-end connector assembly 5 are effectively inserted into each other, that is, whether loosening occurs, can be observed through the observation hole 171, so as to observe whether the two connectors are tightly inserted. As shown in FIG. 1, the board-end connector assembly 5 generally needs to be fixed to an installation board 7 by a plurality of fixing parts 71 such as screws, and thus the fixing parts 71 face the insulating base 11 of the cable-end connector assembly 1. In this embodiment, as shown in FIG. 5, the fixing parts 71 are distributed at four corners on a front side of the board-end connector assembly 5. In order to avoid interference between the fixing parts 71 and the insulating base 11 when the cable-end connector assembly 1 and the board-end connector assembly 5 are inserted into each other, a relieving space is formed in the wall 17 of the insulating base 11. Specifically, the wall 17 is rectangular. The wall 17 includes two tongue portions 173 located at two opposite side surfaces of the wall 17. Side openings 172 are located on two side frames of the wall 17 outside the two tongue portions 173. A height of the side openings 172 is lower than a height of the two tongue portions 173. The side openings 172 form lowered notches at side edges or corners of the wall 17, thereby forming relieving spaces for the raised fixing parts 71.

In addition, the wall 17 further includes limiting protrusions 18 located inside the wall 17. Inner surfaces of the limiting protrusions 18 are connected to the wall 17, and the inner surfaces of the limiting protrusions 18 and the wall 17 form an embedded groove configured to allow the board-end connector assembly 5 to be embedded therein. The positioning portions 14 are located outside the limiting protrusions 18. A height of the limiting protrusions 18 is less than a height of the wall 17. The limiting protrusions 18 may be solid mesa structures or may be formed as partitioning walls. In this embodiment, a quantity of the limiting protrusions 18 located inside the wall 17 may be four, and the limiting protrusions 18 are distributed at four corners. The positioning portions 14 are located between upper and lower limiting protrusions 18. As shown in FIG. 4, in this embodiment, the limiting protrusions 18 define cavities by an inner wall body 181 and the wall 17. A height of the inner wall body 181 is less than the height of the wall 17. Shapes and distributions of the limiting protrusions 18 are disposed to match the board-end connector assembly 5. The inner wall body 181 and the wall 17 located at a side of the inner wall body 181 together form an embedded groove configured to allow the board-end base 51 of the board-end connector assembly 5 to be embedded therein. In this embodiment, lengths of the two upper limiting protrusions 18 are greater than lengths of the lower limiting protrusions 18, and minimum distances between the positioning portion 14 and the upper and lower limiting protrusions 18 may be the same. The wall 17 further includes a plurality of convex ribs 19 on an inner surface of the wall 17. The convex ribs 19 extend parallel to the protruding tubular portions 13. The board-end base 51 of the board-end connector assembly 5 has a plurality of limiting grooves 512. In this embodiment, the limiting grooves 512 are disposed on an outer sidewall of the board-end base 51. Each of a plurality of convex ribs 19 can be correspondingly inserted into the limiting groove 512 for limiting when the cable-end connector assembly 1 and the board-end connector assembly 5 are connected, so as to improve guiding performance and limiting effects during insertion.

As shown in FIG. 1, the present disclosure provides a high-current connector assembly CA. The high-current connector assembly CA includes the cable-end connector assembly 1 and the board-end connector assembly 5 connected to the cable-end connector assembly 1. As shown in FIG. 5, the board-end connector assembly 5 includes a main body 50 and the board-end base 51 protruding from the main body 50 and coupled with the cable-end connector assembly 1. The board-end base 51 has a plurality of sockets 511 configured to receive corresponding protruding tubular portions 13 by insertion of the corresponding protruding tubular portions 13. The sockets 511 run through the board-end base 51 and the main body 50. The board-end connector assembly 5 has a plurality of recessed portions R recessed from the outer sidewall of the board-end base 51. When the board-end connector assembly 5 is coupled with the cable-end connector assembly 1, the board-end base 51 of the board-end connector assembly 5 is embedded into the embedded groove formed by the inner wall body 181 and the wall 17, such that the limiting protrusions 18 are accommodated in the recessed portions R. The board-end connector assembly 5 further includes board-end terminals 52 disposed in the sockets 511 and configured to be electrically connected to the conductive terminal modules 3. The at least one positioning part 6 is disposed on the board-end base 51. The sockets 511 are located between the two positioning parts 6. The fixing parts 71 are disposed at an outer side of the board-end base 51. The board-end connector assembly 5 further has a plurality of installation holes 53 disposed at four corners of the main body 50 and corresponding to the fixing parts 71. The four installation holes 53 are located at an outer side of the board-end base 51, and the installation holes 53 correspond to and are adjacent to the four recessed portions R. By means of the above solution, when the high-current connector assembly CA of the present disclosure is used, the cable-end connector assembly 1 can be directly inserted into the board-end connector assembly 5. During insertion, the protruding tubular portions 13 located on the insulating base 11 are correspondingly inserted into the sockets 511 of the board-end connector assembly 5, and the conductive terminal modules 3 in the cable-end connector assembly 1 and the board-end terminals 52 in the board-end connector assembly 5 realize current conduction. At the same time, the positioning module 2 of the cable-end connector assembly 1 can match the positioning part 6 of the board-end connector assembly 5. For example, positioning is realized by threaded engagement, such that the front panel 12 of the insulating base 11 and the board-end connector assembly 5 maintain a relative position, thereby completing insertion and matching of the two.

Although the present disclosure has been described with reference to the above embodiments, it is not intended to limit the present disclosure. Various modifications and refinements may be made by those skilled in the art without departing from the spirit and scope of the present disclosure. Therefore, the scope of protection of the present disclosure shall be defined by the appended claims.

What is claimed is:

1. A cable-end connector assembly, comprising:
an insulating base comprising a front panel, a plurality of protruding tubular portions extending forward from the front panel, and two positioning portions disposed on opposite sides of the insulating base, wherein each of the protruding tubular portions defines a passage extending through the insulating base;
at least one positioning module disposed on the two positioning portions and raised from the front panel, the at least one positioning module comprising a fastening structure configured to secure the cable-end connector assembly;
a plurality of conductive terminal modules respectively disposed within the protruding tubular portions; and
a plurality of cables individually and electrically connected to the conductive terminal modules.

2. The cable-end connector assembly of claim 1, wherein each of the conductive terminal modules comprises a conductive body and an annular terminal member disposed within a groove formed at a front end of the conductive body, and the conductive body has a connection surface at a rear end thereof for electrically connecting to a corresponding cable.

3. The cable-end connector assembly of claim 1, wherein the two positioning portions have a plurality of through holes extending through the insulating base, each of the at least one positioning module comprises a metal stem respectively received in the corresponding through hole, and the at least one of positioning module further comprises a threaded portion disposed at a front end thereof.

4. The cable-end connector assembly of claim 3, further comprising an internal mold and an external mold, the internal mold wrapping the insulating base and at least one portion of the cables, the external mold wrapping the internal mold, the external mold having a connecting hole located at opposite sides of the external mold and running through the external mold, and the connecting hole corresponding to a rear side of the two positioning portions and located outside the internal mold.

5. The cable-end connector assembly of claim 4, wherein the at least one positioning module is a screw, the screw sequentially passes through the connecting hole of the external mold and the through holes of the insulating base and then protrudes from the front panel.

6. The cable-end connector assembly of claim 1, wherein the protruding tubular portions are divided into an upper row and a lower row and are staggered, and wherein a quantity of the upper row of the protruding tubular portions is less than a quantity of the lower row of the protruding tubular portions.

7. The cable-end connector assembly of claim 1, wherein the insulating base further comprises a wall extending forward from the front panel, and the wall surrounds the front panel such that the protruding tubular portions are enclosed therein.

8. The cable-end connector assembly of claim 7, wherein the wall has at least one observation hole located at two opposite side surfaces of the wall, and the observation hole is located at a front side of the front panel.

9. The cable-end connector assembly of claim 7, wherein the wall further comprises two tongue portions located at two opposite side surfaces of the wall, a side opening is located on two side frames of the wall outside the two tongue portions, and the side opening is formed with a height lower than that of the two tongue portions.

10. The cable-end connector assembly of claim 9, wherein the wall further comprises a plurality of limiting protrusions located inside the wall, inner surfaces of the limiting protrusions and the wall are connected and form an embedded groove configured to allow a board-end connector assembly to embed therein, the two positioning portions are located outside the limiting protrusions, and a height of the limiting protrusions is less than a height of the wall.

11. The cable-end connector assembly of claim 7, wherein the wall further comprises a plurality of convex ribs on inner surface of the wall, the convex ribs extend parallel to the protruding tubular portions.

12. A board-end connector assembly configured to be coupled with a cable-end connector assembly, the board-end connector assembly comprising:
a main body;
a board-end base protruding from the main body and having a plurality of sockets corresponding to a plurality of protruding tubular portions of the cable-end connector assembly, wherein the board-end connector assembly has a plurality of recessed portions recessed from an outer sidewall of the board-end base; and
a plurality of board-end terminals disposed in the sockets.

13. The board-end connector assembly of claim 12, wherein the sockets run through the board-end base and the main body.

14. The board-end connector assembly of claim 12, wherein the board-end base further has a plurality of limiting grooves disposed on the outer sidewall of the board-end base and separated from the recessed portions, and the limiting grooves correspond to a plurality of convex ribs of the cable-end connector assembly.

15. The board-end connector assembly of claim 12, further comprising at least one positioning part disposed on the board-end base and configured to be threadedly connected to a threaded portion of at least one positioning module of the cable-end connector assembly.

16. The board-end connector assembly of claim 15, wherein the board-end connector assembly comprises the two positioning parts, and the sockets are located between the two positioning parts.

17. The board-end connector assembly of claim 15, wherein the at least one positioning part is a nut, when the cable-end connector assembly is connected to the board-end connector assembly, a front end of the at least one positioning module of the cable-end connector assembly inserts into the nut.

18. The board-end connector assembly of claim 12, further comprising a plurality of installation holes disposed on the main body and located at an outer side of the board-end base.

19. The board-end connector assembly of claim 18, wherein the installation holes disposed at four corners of the main body, and the installation holes correspond to and adjacent to the recessed portions.

20. A high-current connector assembly, comprising:
a cable-end connector assembly comprising:
an insulating base having a plurality of protruding tubular portions and at least one positioning module separated from the protruding tubular portions;
a plurality of conductive terminal modules disposed within the protruding tubular portions; and
a plurality of cables electrically connected to the conductive terminal modules; and
a board-end connector assembly connected to the cable-end connector assembly, the board-end connector assembly comprising:
a board-end base configured to be coupled with the cable-end connector assembly;
a plurality of sockets configured to receive the protruding tubular portions; and
at least one positioning part configured to be engaged with the at least one positioning module of the cable-end connector assembly.
